(19) United States
(12) Patent Application Publication
(10) Pub. No.: US 2009/0015798 A1
(43) Pub. Date: Jan. 15, 2009

(54) Mounting for Interactive Display System

(75) Inventor: Peter Unsworth, North Yorkshire (GB)

Correspondence Address: SALIWANCHIK LLOYD & SALIWANCHIK;A PROFESSIONAL ASSOCIATION, PO BOX 142950, GAINESVILLE, FL, 32614-2950, US

(73) Assignee: Promethean Limited, Blackburn (GB)

(21) Appl. No.: 12/064,931

(22) PCT Filed: Aug. 26, 2005
(86) PCT No.: PCT/GB2005/003342

§ 371 Date: Aug. 28, 2008

(51) Int. Cl. G03B 21/10; G03B 21/14

(52) U.S. Cl. 353/79; 353/119

(57) ABSTRACT

The subject invention concerns a display system comprising an interactive display surface and a projector for projecting images onto the display surface. The display surface and the projector are movable in a vertical direction. Calibration between an image projected from the projector and displayed on the interactive display surface is maintained. Following movement of the display screen and the projector, no re-calibration of the interactive display is required. The movement in a vertical direction is between at least two positions for projecting images onto the display surface. The movement may be continuously between said two positions or in discrete steps.

The invention relates to display systems and more particularly to a projection-based interactive display system.

A typical example of an interactive display system is an electronic whiteboard system. An electronic whiteboard system typically is adapted to sense the position of a pointing device or pointer relative to a working surface of the whiteboard, the working surface being an interactive surface. When an image is displayed on the work surface of the whiteboard, and its position calibrated, the pointer can be used in the same way as a computer mouse to manipulate objects on the display by passing the pointer over the surface of the whiteboard. In a typical arrangement the image is projected onto the working surface of the display using a projector.

A typical application of an interactive whiteboard system is in a teaching environment. The use of interactive whiteboards improves teaching productivity and also improves student comprehension. Such whiteboards also allow use to be made of good quality digital teaching materials, and allow data to be manipulated and presented using audio visual technologies.

A typical construction of an electronic whiteboard comprises providing an array or matrix of drive and sense coils behind or underneath the working surface of the whiteboard to thereby form an interactive surface, which coils interact with electromagnetic elements in the pointer device.

In current whiteboard system arrangements the pointing device is typically provided as a pen-style device. It has been typically considered that a pen-style device is a natural choice for use with an interactive surface since it mimics the action of pen-on-paper that most users are familiar with. The use of such a pen-style device requires the user of the system to be adjacent the working surface of the whiteboard system when using the system.

In a conventional classroom environment a working surface of an interactive display system is typically wall mounted by means of mounting brackets fixed to a wall.

The mounting height of the whiteboard system is typically determined by a convenient height for a teacher. This may often result in the whiteboard system not being in the optimum position for child use. The situation is particularly an issue with respect to young children. In some situations, the whiteboard system may be mounted relatively low in order for young children to be able to use it. However this results in poor accessibility to the whiteboard system for a teacher. Additionally in some schools the whiteboard system may be used across a wide age range of students and by teachers of differing stature. An additional situation where the fixed height of the whiteboard system is problematic is with users who are disabled in some way, for example wheelchair-bound.

One solution to these problems is to provide multiple fixing positions on a wall for the whiteboard system, which allow the board to be fixed at different heights. However this would involve the physical movement of the board after each use, and the readjustment of the projector angle. Such an arrangement would be unsatisfactory in practice.

The projector of a whiteboard system is typically ceiling mounted to provide the optimum optical, environmental and security considerations for installation. The provision of a ceiling mounted projection system does however add some degree of complexity to the installation of systems. In addition to fixing the whiteboard to the wall, which is a relatively simple task, the projector is thus ideally fitted to the ceiling. The positioning of the projector is critical, to ensure the clear display of images on the display area of the whiteboard system. Difficulties may also be presented in ensuring that the ceiling provides a safe and secure fixing point for the projector.

It is an aim of the invention to provide an improved display system which addresses one or more of the above-stated problems.

In accordance with the invention there is provided a display system comprising a display surface and a projector for projecting images onto the display surface, wherein the display surface and the projector are movable in a vertical direction.

The display surface and the projector are preferably movable in a vertical direction between at least two positions for projecting images onto the display surface. The display surface and the projector may be movable continuously between said two positions. The display surface and the projector may be movable in discrete steps between said two positions.

The display surface is preferably an interactive display surface. Calibration between an image projected from the projector and displayed on the interactive display surface is maintained in each position. Following movement of the display screen and the projector, preferably no re-calibration of an interactive display system of which they are a part is required.

The display surface and the projector may be movable in dependence on each other. Thus movement of one or the other of the display surface or the projector results in a corresponding movement of the other.

The display surface and the projector may be attached to each other. The display surface and the projector may be directly or indirectly attached to each other.

The display system may be movably attached to a wall or a stand. The display surface and the projector may each be attached to a movable mounting.

The projector may be fixably attached to the display surface.

The display surface and the projector may be movable independent of each other. The display surface may be movably attached to a wall. The display surface may be movably attached to a stand. The projector may be movably attached to a ceiling. The projector may be movably attached to a wall. The projector may be movably attached to the display surface.

The invention further provides a method of adjusting the height of a display surface of a display system including a projector for projecting images on to the display surface, comprising moving the display surface and the projector in a vertical direction.

The step of adjusting the display surface and the projector in a vertical direction may comprise moving each a corresponding distance, such that the relationship between the projector and the display surface is unchanged.

Said adjustment may be exclusively in a vertical direction. Preferably no additional adjustment of the projector is required.

The invention is described by way of example with reference to the accompanying Figures, in which:

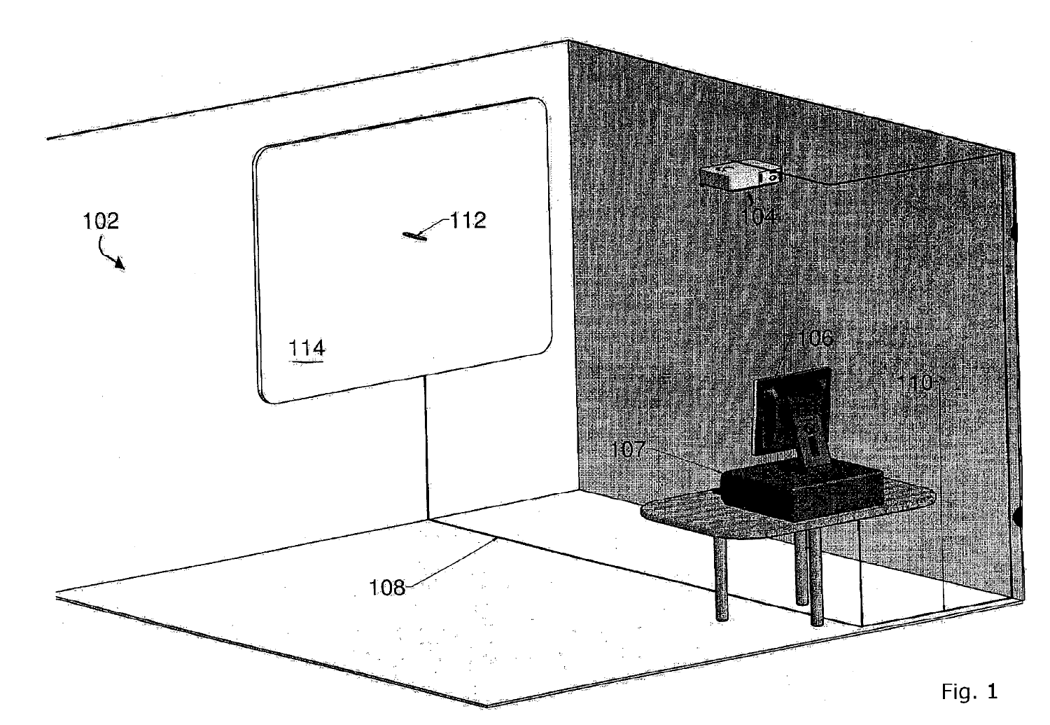

FIG. 1 illustrates an example of an interactive display system;

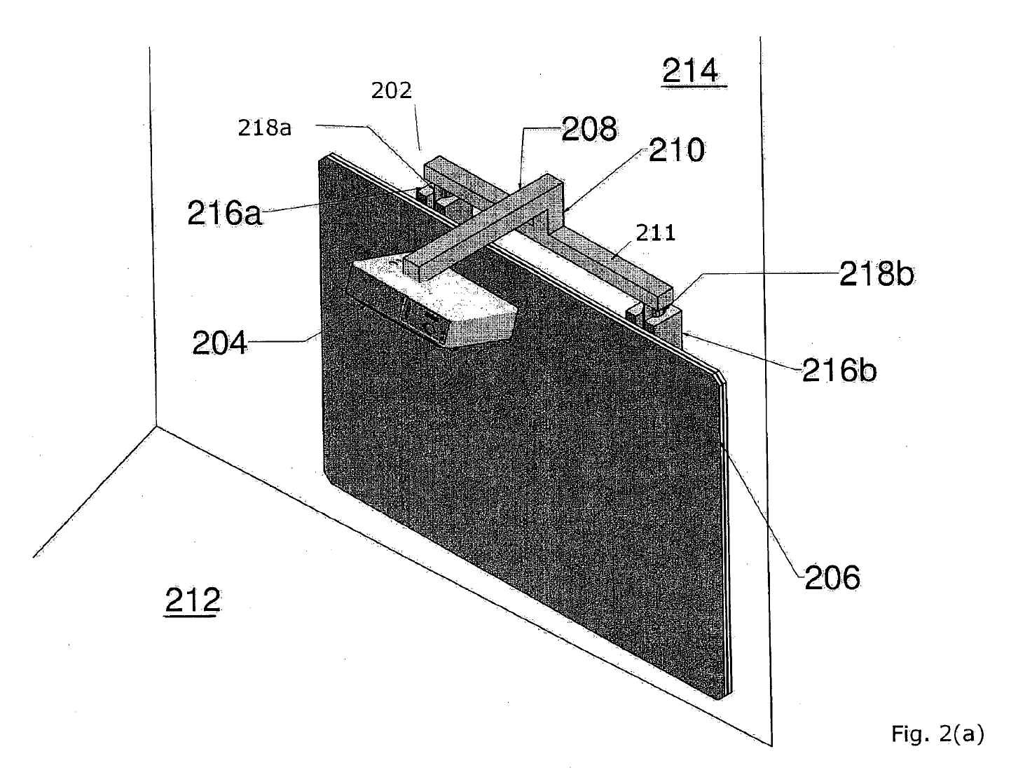

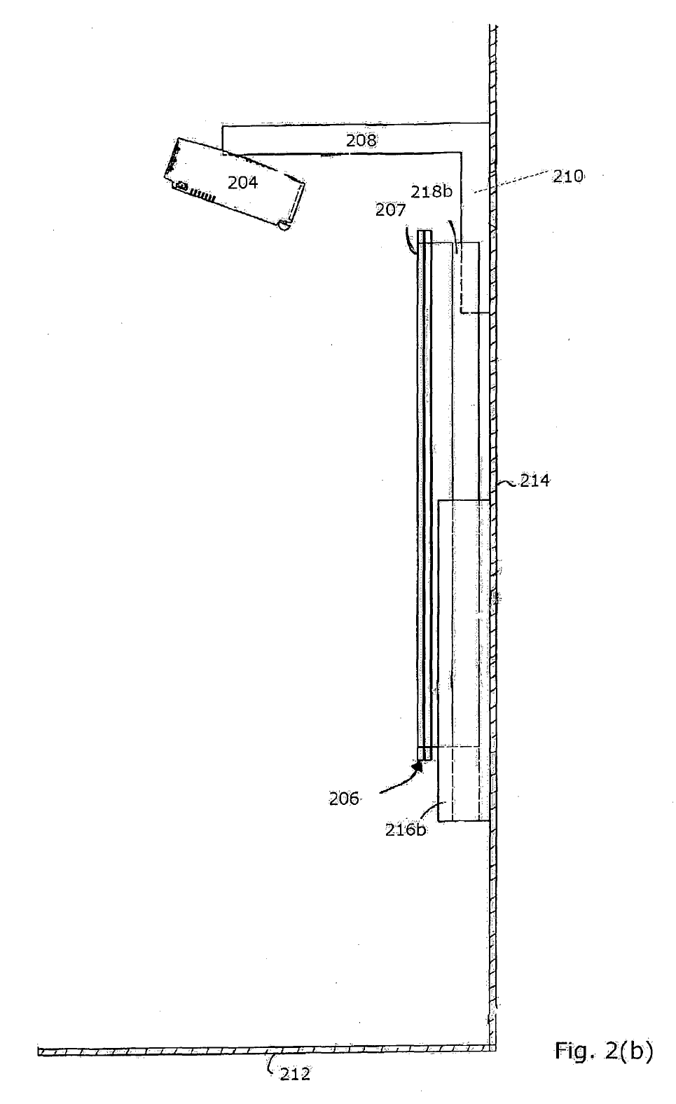

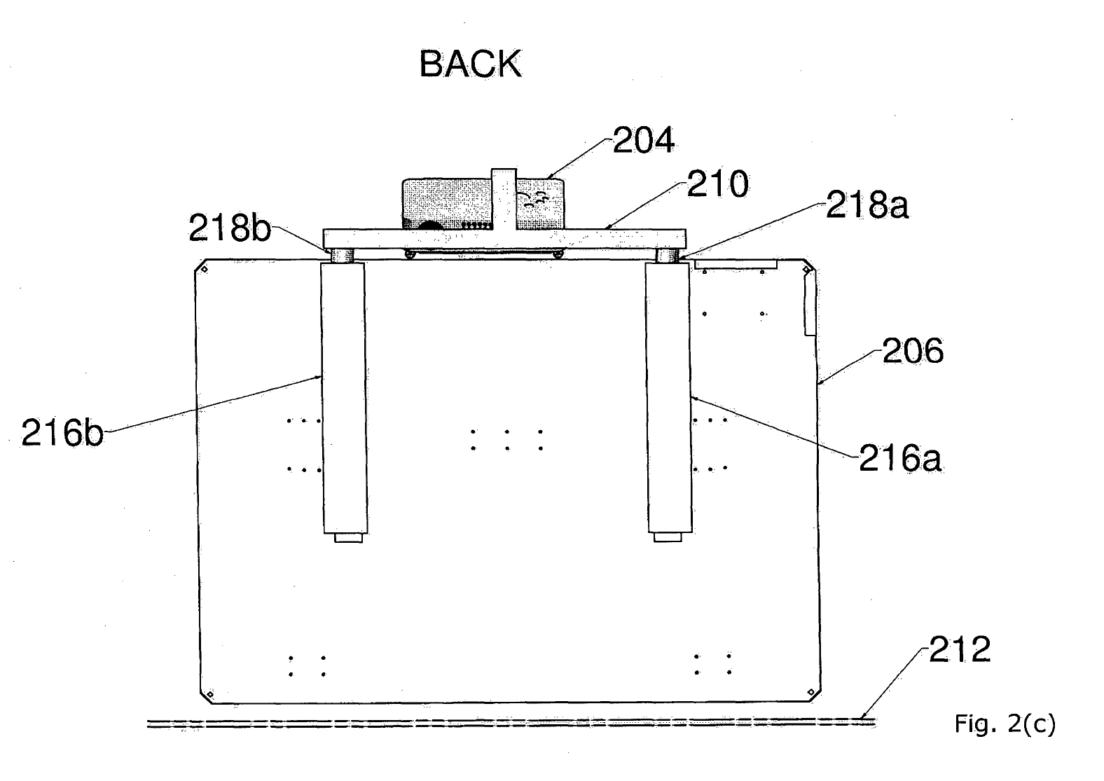

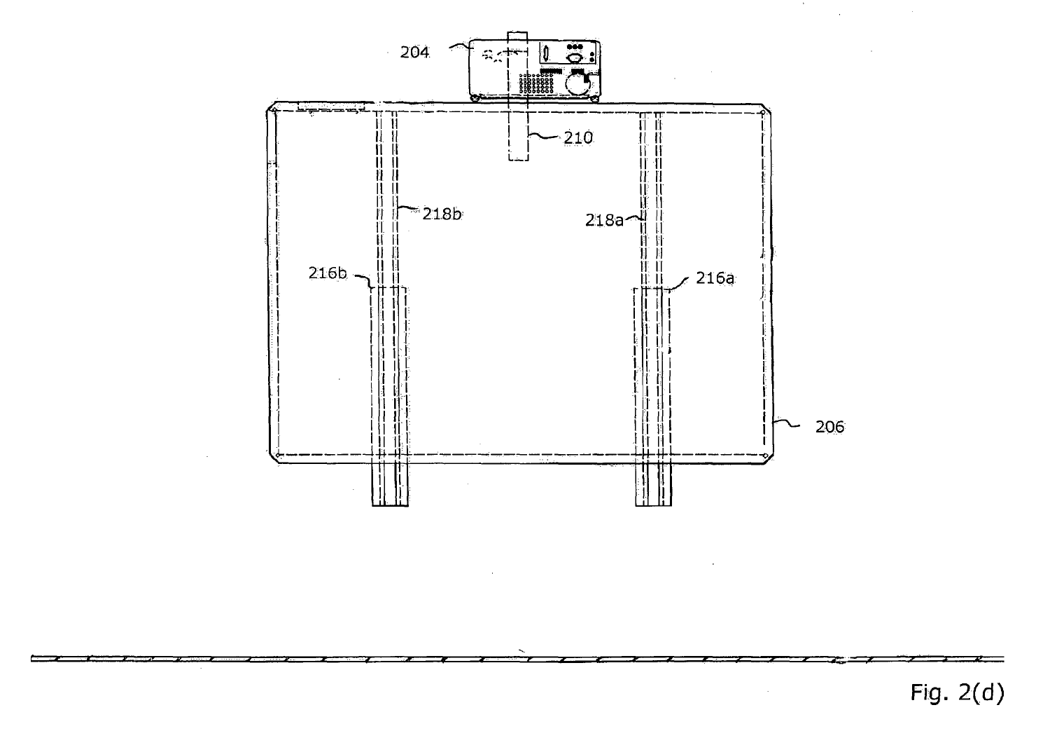

FIGS. 2(a) to 2(d) illustrate an interactive display system arrangement in accordance with a first embodiment of the invention;

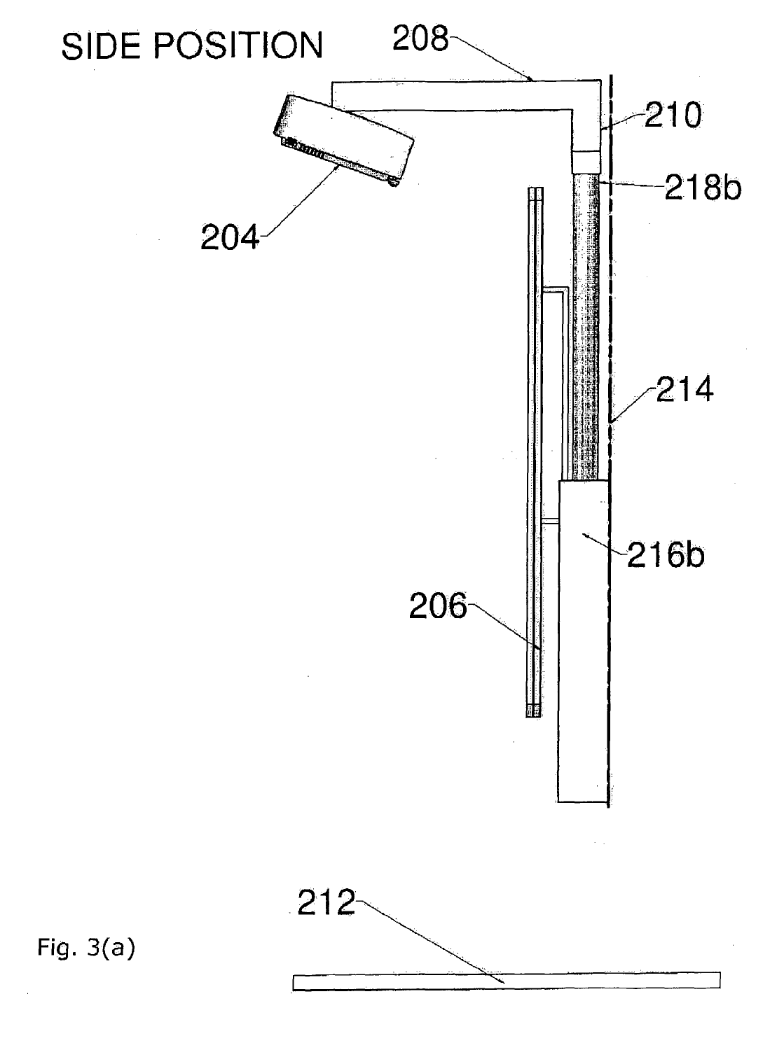

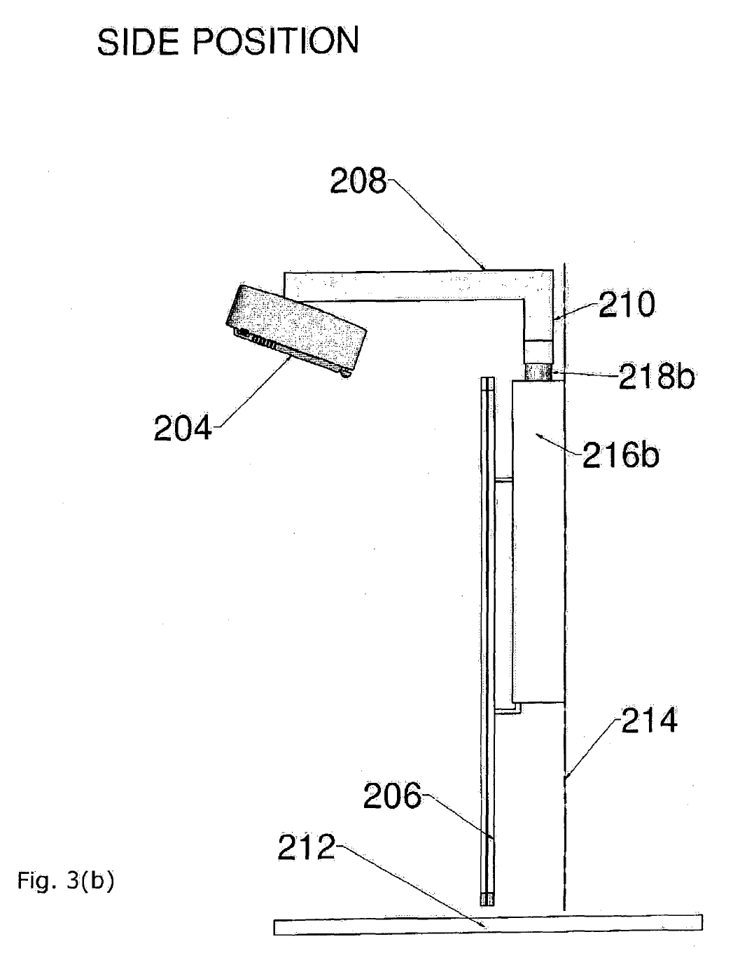

FIGS. 3(a) and 3(b) further illustrate the arrangement of FIG. 2(a) to 2(d);

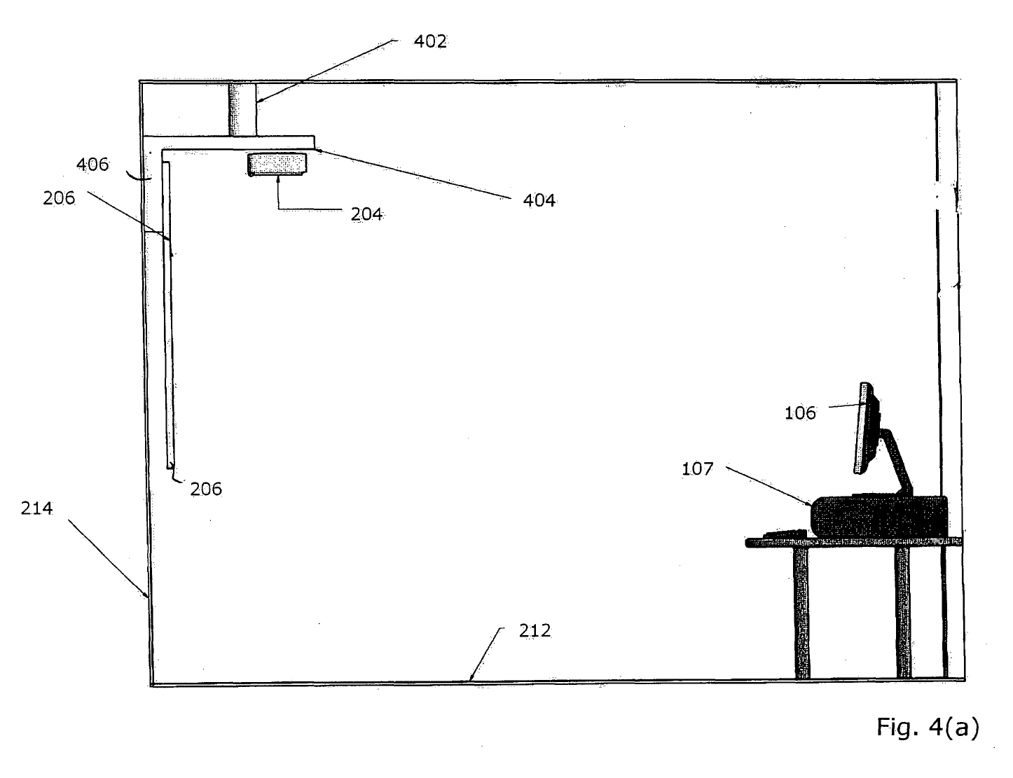

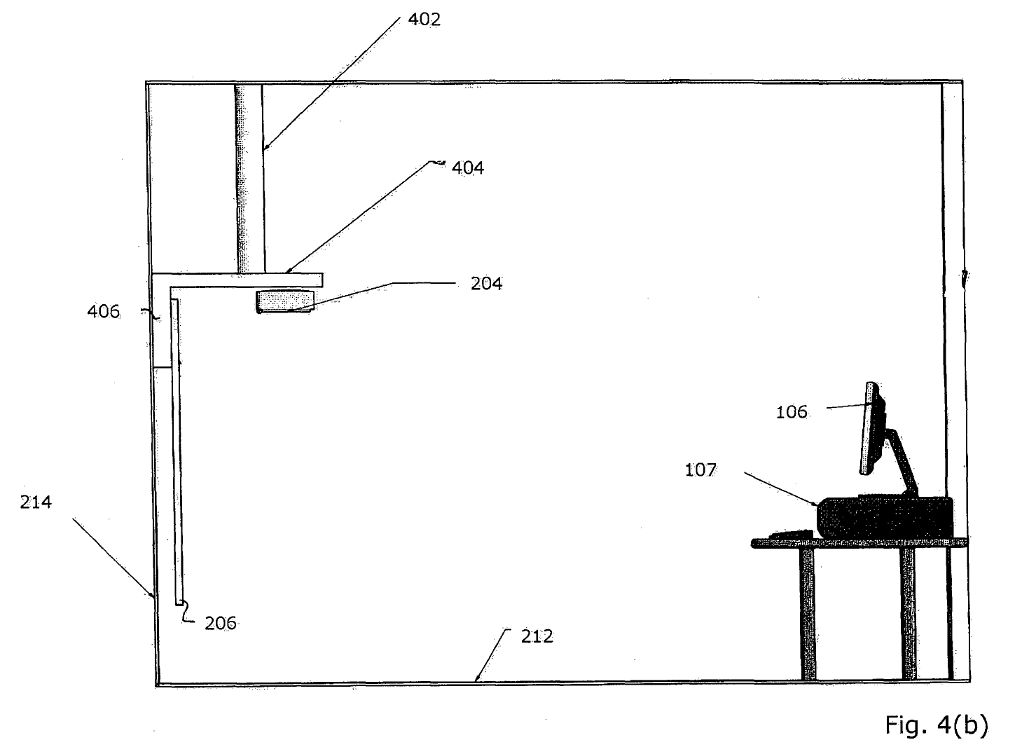

FIGS. 4(a) and 4(b) illustrate an interactive display system arrangement in accordance with a second embodiment of the invention; and

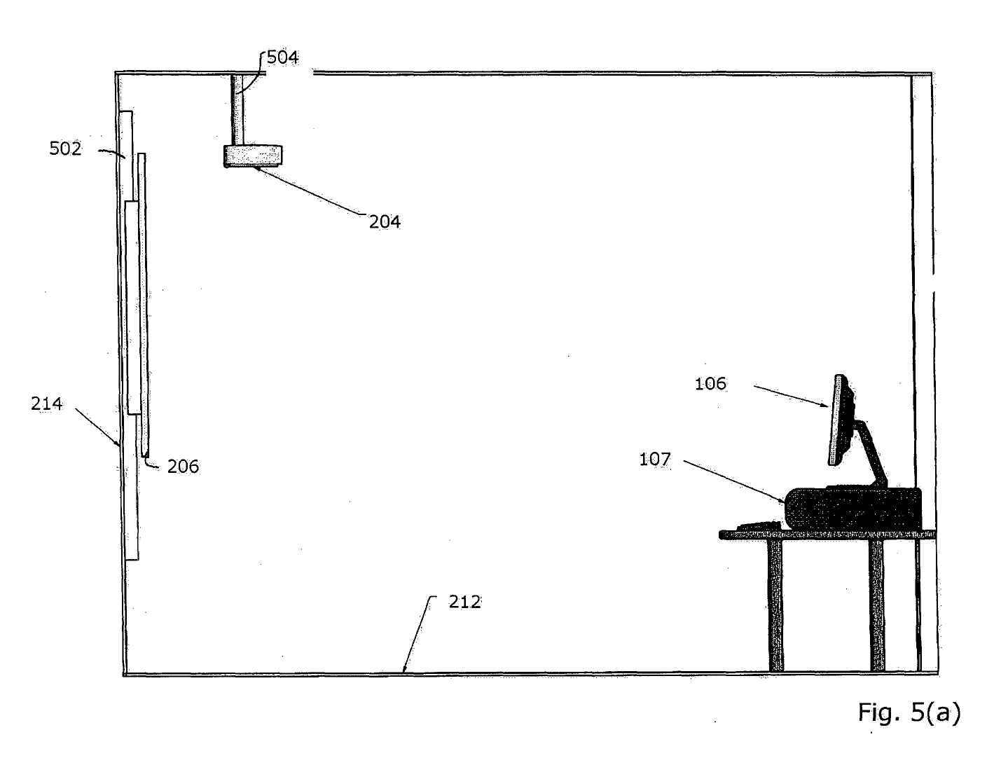

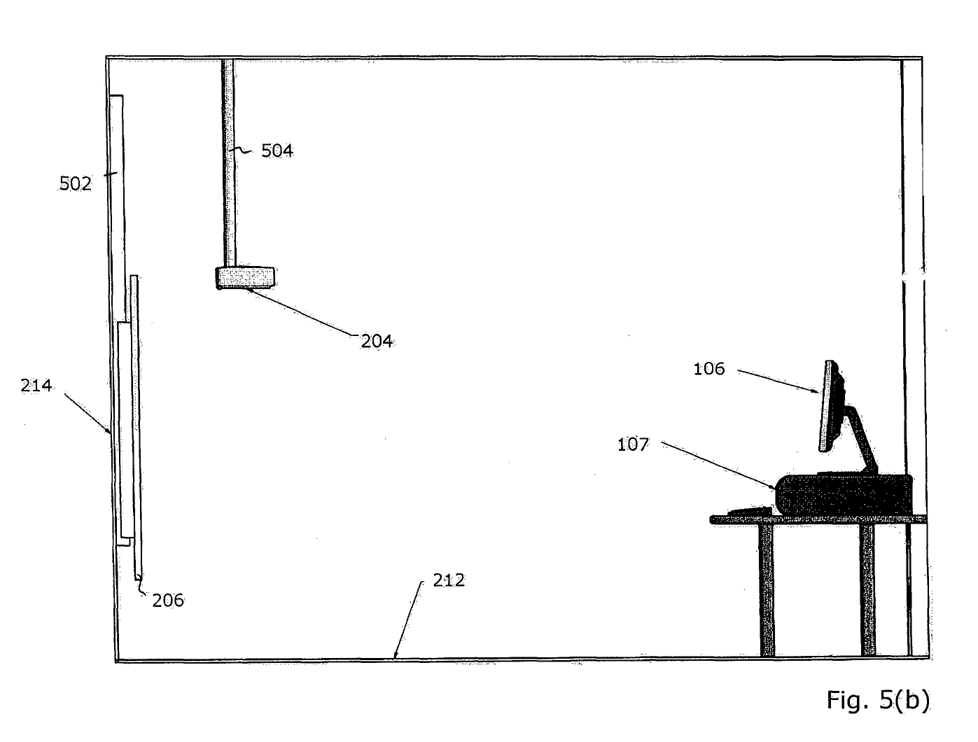

FIGS. 5(a) and 5(b) illustrate an interactive display system arrangement in accordance with a second embodiment of the invention.

Referring to FIG. 1, a typical interactive display system comprises a whiteboard assembly arrangement generally designated by reference numeral 102, a computer 107 having an associated display 106, and a projector 104. The computer 107 is connected to the whiteboard assembly arrangement 102 via a communication link 108, and to the projector 104 via a communication link 110. The projector 104, which may be fitted to a ceiling of a room such as a classroom, receives signals from the computer 107 which are translated into corresponding projection images for projection onto a display surface 114 of the whiteboard assembly arrangement 102.

The image projected on the display surface 114 of the whiteboard assembly arrangement 102 may be the same as that displayed on the screen 106 of the computer 107.

The interactive display system also includes one or more pointing devices or pointers, as represented by pointing device 112, which cooperate with the whiteboard assembly arrangement 102. The pointing device 112 is moved across the display surface 114 of the whiteboard assembly arrangement 102, in contact with or close to the surface. The position of the pointing device 112 relative to the display surface 114 of the whiteboard assembly arrangement 102 is, in one type of arrangement, detected electronically by means of a conductive grid embedded beneath the display surface 114. The pointing device 112 may be moved around the display surface 114 to write on the display surface, for example, or to highlight images displayed on the display surface. The use of such a pointing device in combination with a whiteboard assembly arrangement is well-known to one familiar with the art.

Using methods known in the art, the pointing device 112 can function in the same way as a computer mouse. The pointer may be provided with buttons or such like which may be depressed, to provide for functional operations in much the same way as buttons may be provided on a computer mouse. For example, by depression of a button a displayed icon over which the pointing device 112 is positioned may be selected. By further example, by depression of a button the functional operation of the pointer may change from a pen to an eraser.

In general, the movement of the pointing device 112 across the display surface 114 is detected by the embedded grid array, and such movement translated to be superimposed on the displayed image, such that the displayed image projected by the projector 104 is adapted to display any required action associated with the pointing device, as is known in the art.

The structure of the whiteboard assembly arrangement and the pointing device for operation of the interactive display system may be one of several different implementations. In a preferred arrangement the whiteboard assembly arrangement 102 includes a grid portion behind the display surface, which comprises two sets of conductive loops arranged orthogonally to each other. The pointing device 112 is adapted to induce a current in the conductive loops which can be used to determine the position of the pointing device 112. In a particularly preferred arrangement the pointing device 112 is a passive electromagnetic device: a drive grid induces a current in the pointing device, which in turn induces a current in a sense grid. The operation of such an arrangement is known in the art. A more detailed discussion of such a system may be found in European Patent No. 0607694.

A first embodiment of the invention is now described by way of reference to FIGS. 2(a) to 2(d).

In the first described embodiment, the interactive display system is implemented using a projection system with a very short ‘throw’ optical system. Such systems are known in the art, and the invention is not limited to any specific arrangement of such a system. Reference can be made to U.S. Pat. Nos. 6,540,366 and 6,394,610 for examples of such systems. As discussed further herein below, however, the invention is not limited to very short ‘throw’ projections systems.

In the following description, like reference numerals are used to identify elements in different figures which are the same.

Referring to FIGS. 2(a) to 2(d), an interactive display system incorporating a very-short ‘throw’ projection system is generally designated by reference numeral 202. The interactive display system is set-up in a room having a wall 214 and a floor 212.

FIG. 2(a) illustrates a plan view of the system set-up in the room. FIG. 2(b) illustrates a cross-sectional view of the system looking sideways into the room. FIG. 2(c) illustrates a rear view of the system looking into the room from behind the wall to which the system is mounted. FIG. 2(d) illustrates a front view of the system showing hidden detail behind the whiteboard assembly arrangement 202.

The interactive display system 202 includes a projection system including a projector 204 and a whiteboard assembly arrangement 206, which includes an interactive display surface as known in the art.

The whiteboard assembly arrangement 206 is mounted on the wall 214. In accordance with this embodiment of the invention, two elongated actuators 216a and 216b are mounted vertically on the wall 214, for respective engagement with two elongated rails 218a and 218b attached to the rear of the whiteboard assembly arrangement 206. The engagement of the two elongated actuators 216a and 216b with the two elongated rails 218a and 218b attaches the whiteboard assembly arrangement 206 to the wall.

The projector 204 is attached to one end of a horizontal boom 208, the other end of which boom 208 is connected to one end of a vertical support arm 210. In the illustrated arrangement the vertical support arm 210 is further attached to a horizontal support arm 211, the ends of which are attached to the upper ends of the elongated rails 218a and 218b.

In a first arrangement of the first embodiment of the invention the projector 204 is effectively integral with the whiteboard assembly arrangement 206. As such, the projector 204 is attached to the whiteboard assembly arrangement 206 in a fixed manner.

The two elongated actuators 216a and 216b fixed to the wall 214 cooperate with the two elongated rails 218a and 218b fixed to the rear of the whiteboard assembly arrangement 206 such that the whiteboard assembly arrangement is movable vertically between at least two positions. In the embodiment shown in FIGS. 2(a) to 2(d), the whiteboard assembly arrangement 206 is continuously movable vertically in a range between a minimum and a maximum height. In this way the height of the working surface of the whiteboard assembly arrangement may be adjusted. It will be appreciated that the maximum and minimum height is determined by the location of the two elongated actuators 216a and 216b on the wall 214, and length of the two elongated actuators 216a and 216b.

The specific arrangement for adjusting the height of the whiteboard assembly arrangement as shown in FIGS. 2(a) to 2(d) is only an exemplary arrangement, and the invention is not limited to such an arrangement. The arrangement may preferably be any form of linear slide mechanism, and need not rely upon the physical effort of a user to adjust the height. In one arrangement the mechanism may be adapted to include mechanical means for adjusting the height of the whiteboard assembly arrangement, for example by inclusion of a rack and pinion system and hand wheel. In another arrangement the mechanism may be adapted to include electrical means for adjusting the height of the whiteboard assembly arrangement, for example via some form of electrically powered actuator. In a further arrangement the mechanism may be adapted to include a counter balance system for adjusting the height of the whiteboard assembly arrangement, for example via a gas strut or counterweight.

In should be noted that any mechanism that allows the height of the whiteboard assembly arrangement to be adjusted, by movement thereof between at least two distinct vertical positions, may be utilised in combination with embodiments of the invention. The movement does not have to be a linear vertical movement, although in practice a linear mechanism may not be most efficient. The required characteristic is that the display surface is moveable between at least two vertical positions, such that the display surface may be provided for use in at least two alternative height positions.

It should be noted also, for example, that in an arrangement where cooperating rails and actuators are used, such as is shown in FIGS. 2(a) to 2(d), there may be provided a single rail/actuator arrangement, for example in a vertically central position relative to the whiteboard assembly arrangement, or more than two rail/actuator arrangements.

As is illustrated in the embodiment of FIGS. 2(a) to 2(d), whiteboard assembly arrangement mounting brackets may be fixed to the two elongated rails 218a and 218b, rather than to the wall as in prior art arrangements such as shown in FIG. 1. The whiteboard assembly arrangement is then installed so as the rails 218a and 218b engage with the actuators 216a and 216b, which are fixed to the wall. In general, it can be considered that a sliding portion of a slide mechanism has mounted upon it the whiteboard assembly arrangement.

In the arrangement of the embodiment described with reference to FIGS. 2(a) to 2(d), the projector is indirectly fixed to the whiteboard assembly arrangement. As such when the whiteboard assembly arrangement is moved vertically, the projector moves with it, and the geometrical arrangement of the projector and whiteboard assembly arrangement remains fixed regardless of the movement of the whiteboard assembly. The consequence of this is that irrespective of the movement of the vertical position of the whiteboard assembly arrangement, the image projected by the projector remains in calibration with the interactive display surface of the whiteboard assembly arrangement. Thus the height of the whiteboard assembly arrangement, and hence the display surface, can be easily and quickly adjusted, to a convenient height for a user, without recalibration or image adjustments. This is very advantageous, especially where there is wide variation in the height or mobility of users.

In the described arrangement of the first embodiment, it is described that the two elongated rails 218a and 218b are fixed to the rear of the whiteboard assembly arrangement 206. In an alternative the whiteboard may clip onto mounting brackets fixed to the two elongated rails 218a and 218b. In general the whiteboard may be fixably or removably attached to the sliding or movable portion of the mounting arrangement.

It should also be noted that the whiteboard assembly arrangement may be mounted on a stand rather than a wall, with the stand being similarly adapted to cooperate with the whiteboard assembly arrangement fixings thereto to allow vertical position adjustment thereof.

In the illustrated arrangement of the first embodiment, the projector is integral with the rails 218a and 218b, which are in turn attached to the whiteboard assembly arrangement. In general, in this arrangement of the embodiment, the whiteboard assembly arrangement is attached to the sliding part of the linear slide mechanism, and the projector (via the boom and vertical support arm) is attached to the sliding part of the linear slide mechanism. When the sliding part of the slide mechanism moves, due to for example forces exerted on the whiteboard assembly arrangement 206, the projector 204 is subject to a corresponding movement. In this way the image projected by the projector remains in calibration with the display surface. In an alternative arrangement the projector may be attached directly to the whiteboard structure itself, via the boom and the vertical arm. In general in accordance with this embodiment of the invention, the projector is mounted such that it moves when the whiteboard moves, and maintains a fixed relationship with the whiteboard. The whiteboard assembly arrangement is therefore attached or fixed directly or indirectly to the projector.

It should be noted that generally the projector is positioned central to the whiteboard, for displaying the image centrally on the whiteboard surface.

As mentioned hereinabove, the whiteboard assembly arrangement is preferably arranged such that it can be moved in a range between a minimum height and a maximum height. The mechanism which allows the position of the whiteboard assembly to be adjusted will preferably include appropriate means for stopping the movement of the whiteboard assembly arrangement at the extremes of the range. The whiteboard assembly arrangement may be movable continuously between a maximum and minimum height position, or in discrete steps. In the limit, the discrete steps may only be between those two positions corresponding to the maximum and minimum height positions.

FIGS. 2(a) to 2(d) show the whiteboard assembly arrangement in a raised position, with the whiteboard assembly arrangement clear of the floor 212. In such an arrangement the board may be at a convenient height for an adult teacher, for example.

With reference to FIGS. 3(a) and 3(b) there is shown side views of the whiteboard assembly arrangement in a raised position and a lowered position respectively. In the raised position, as shown in FIG. 3(a), the whiteboard assembly arrangement is raised from the floor, with the elongated rails 218a and 218b extending from the actuators 216a and 216b. In the lowered position, as shown in FIG. 3(b), the whiteboard assembly arrangement is positioned proximate the floor 212. In certain environments, the fitting of the whiteboard assembly arrangement may be arranged such that in a lowered position the whiteboard assembly arrangement rests on the floor.

The arrangement of the first embodiment, where the projector is directly or indirectly integrally formed with the whiteboard system by a boom, offers advantages in terms of installation. It is possible to pre-wire the projector and whiteboard in the factory rather than on-site, and this in-turn leads to a simpler and quicker installation. Additionally in situations where asbestos is contained in the ceiling space, the benefits of a ceiling mounted projector installation are possible without the need for disturbing the ceiling area. The use of a very short ‘throw’ projector also provides less shadowing of the image and less glare for the user.

In a second described embodiment the integral whiteboard assembly arrangement and projector may be arranged to be attached to the ceiling rather than to the wall. This second embodiment is further described with reference to FIGS. 4(a) and 4(b). FIGS. 4(a) and 4(b) show only a side illustration.

Referring to FIG. 4(a) an actuator 402 is connected at one end to a ceiling and at another end to a horizontal beam 404. The whiteboard assembly arrangement 206 and the projector 204 are both attached to the horizontal beam 404.

A suitable fixing arrangement is provided on the whiteboard assembly arrangement to enable attachment to the horizontal beam 404. As shown in FIGS. 4(a) and 4(b), for example, the horizontal beam 404 may have a downward vertical extension 406 at an end thereof proximate to which the whiteboard assembly arrangement is attached. The vertical extension 406 extends downwardly from the horizontal beam 404. The whiteboard assembly arrangement 206 may then be provided with fixing means, such as brackets, toward the top rear thereof for attaching to the vertical extension 406.

The projector 204 is preferably mounted at the other end of the horizontal beam 404 to the whiteboard assembly arrangement 206.

The horizontal beam 404 may be formed in any suitable way in order to provide for the attachment of the whiteboard assembly arrangement 206 and the projector 204 to the actuator 402. The horizontal beam 402 may be a single support beam extending away from the whiteboard assembly arrangement, in much the same manner as the boom 208 illustrated in FIGS. 2(a) to 2(d). However any appropriate mechanical arrangement to attach the projector and whiteboard assembly arrangement to the actuator 402 may be utilised.

The actuator 402 may be any suitable extendable means. The actuator 402 enables the height of the whiteboard assembly arrangement to be adjusted. The actuator is adapted such that the horizontal beam 404 may be moved vertically, and consequently the projector and whiteboard assembly arrangement may be moved vertically. The attachment of the whiteboard assembly arrangement and the projector to the horizontal beam results in the whiteboard assembly arrangement and the projector moving, in fixed relationship, as the horizontal beam is moved. The actuator 402 may be implemented as any suitable means. For example a vertical rail may be attached to the horizontal beam, which engages the actuator 402. The actuator may be controlled mechanically or electrically, for example by remote control.

FIG. 4(a) shows the arrangement of the second embodiment with the whiteboard assembly arrangement and projector in a raised position. FIG. 4(b) shows the arrangement of the second embodiment with the whiteboard assembly arrangement and projector in a lowered position.

In an alternative arrangement of the second embodiment, the actuator 402 may be fixed to the floor, with the whiteboard assembly arrangement and projector attached above the actuator. In such an arrangement, which may be provided as a stand arrangement, the whiteboard assembly arrangement is preferably fixed to the actuator toward the bottom thereof, and the projector may be fixed to the whiteboard assembly arrangement via a boom arrangement as shown in FIG. 2(a) to 2(d).

In a third described embodiment of the invention, the whiteboard assembly arrangement may be configured to be mounted on the wall (or a stand) such that it may slide vertically on the wall in a similar manner to that described with reference to FIGS. 2(a) to 2(d). However the projector may be positioned, in accordance with the third embodiment, separately on the ceiling, in an arrangement similar to that shown in FIG. 1. In this embodiment, the projector is also arranged to be moveable vertically, so if the height of the whiteboard assembly arrangement is adjusted, the height of the projector is also adjusted.

An arrangement in accordance with the third embodiment is shown in FIGS. 5(a) and 5(b). FIGS. 5(a) and 5(b) show only a side illustration.

The whiteboard assembly arrangement 206 is attached to the wall 214 by means of an actuator arrangement 502. The projector 204 is attached to the ceiling by means of an actuator arrangement 504.

The actuator arrangement 502 associated with the whiteboard assembly arrangement may be the actuator and rail arrangement described hereinabove with reference to FIGS. 2(a) to 2(d). In general the actuator 502 enables the whiteboard assembly arrangement to move vertically up and down the wall between at least two positions.

The actuator arrangement 504 associated with the projector 104 may be similar to the actuator arrangement 402 illustrated in FIGS. 4(a) and 4(b). In general the actuator 504 enables the projector to move vertically up and down between at least two positions.

In operation, the whiteboard assembly arrangement is moved vertically from a start position to a required position for use. The projector is then moved a corresponding distance from a start position, such that an image is projected onto the display surface of the whiteboard assembly arrangement.

In the arrangement of FIGS. 5(a) and 5(b), the mechanism for the movement of the whiteboard assembly arrangement is clearly independent of the mechanism for the movement of the projector.

The actuator of the whiteboard assembly arrangement may be configured to be movable between two or more discrete vertical positions, and the projector similarly be configured to be moveable between two or more discrete vertical positions, such that if the whiteboard assembly arrangement is moved to a given discrete position, the projector may be moved to a corresponding given discrete position. Alternatively the whiteboard assembly arrangement and the projector may be continuously movable between two extreme positions.

The actuators 502 and 504 may be provided with a common control means. This control means could, for example, be an electrical control means. Using a remote control device, for example, the user may select an upward or downward movement, and responsive to a control entered at the remote control device signals sent to both the actuators 502 and 504 to move accordingly in a synchronised fashion. It will be understood by one skilled in the art that other electrical or mechanical means may be provided for synchronising the movement of the actuators 502 and 504.

The third embodiment described in relation to FIGS. 5(a) and 5(b) does have some disadvantages compared with the first and second embodiment, due to the fact that the relationship between the whiteboard assembly arrangement and the projector is not fixed. This means that some additional care may be needed when moving the two elements, to ensure that the appropriate positioning relationship is maintained and that re-calibration of the interactive surface relative to the projected image is not required frequently. This disadvantage is, however, avoided if some form of synchronised control of the two actuators is provided.

However the embodiment illustrated in FIGS. 5(a) and 5(b) also has advantages over the first and second embodiments. For example, the separate positioning and fixing of the projector and the whiteboard assembly arrangement provides for more versatility in the type of projector system that may be used, and will likely allow for less dependency on a short throw projection system.

In general, it can be seen that the various described embodiments of the invention allow for the height of the display surface of a projection based display system to be adjusted, whilst maintaining the position of the projected display on the display surface. More particularly the embodiments enable the calibration of the displayed image on an interactive display surface to be maintained as the height of the interactive display surface is adjusted. This is preferably achieved through the projector of the projection system being integrally linked with the display surface, such that movement of the display surface caused corresponding movement of the projector.

Features of the various embodiments of the invention may be combined and interchanged. The embodiments are not exclusive embodiments. Of each of the three embodiments described, any aspects of one embodiment may be introduced into one or other of the other embodiments in place of or in combination with any aspect of any embodiment.

Whilst being particularly suited to very short ‘throw’ projection systems, the invention is not limited to such. Whilst the foregoing embodiments are presented in the context of very short ‘throw’ projection systems, it will be apparent to one skilled in the art that the principles of the invention as exemplified by these embodiments may apply to any projection system. The limitation in the first and second embodiments being a mechanical one, namely the provision of a suitable strength boom for connecting the projector.

It should be noted that although the description herein is presented in the context of an interactive display system incorporating a whiteboard assembly arrangement, the invention is not limited to such. The invention is generally applicable to any display system utilising a projection system for displaying images on a display surface. The invention is particularly advantageously applied to interactive display systems, where the positioning of the projected image on a display surface must be synchronised or calibrated with the surface, in order for example to detect the location of a pointing device relative to the displayed image.

Embodiments of the invention are not limited to any specific interactive display system arrangement. For example the interactive display system may use passive electromagnetic positioning technology or an active pointer device. The interactive display system may utilise touch-sensitive technology rather than a pointer which cooperates with an electromagnetic interactive surface. In general, the invention applies to display systems in which a projection system is used to display images on a display surface.

We claim:

1. A display system comprising: a display surface; and a projector for projecting images onto the display surface, wherein the display surface and the projector are movable continuously in a vertical direction.

2. The display system according to claim 1, wherein the display surface and the projector are movable in a vertical direction between at least two positions for projecting images onto the display surface.

3. A The display system according to claim 1, wherein the display surface is an interactive surface.

4. The display system according to claim 1, wherein calibration between an image projected from the projector and displayed on the display surface is maintained.

5. The display system according to claim 1, wherein the display surface and the projector are movable in dependence on each other.

6. The display system according to claim 5, wherein the display surface and the projector are attached to each other.

7. The display system according to claim 6, wherein the display surface and the projector are directly or indirectly attached to each other.

8. The display system according to claim 1, wherein the display system is movably attached to a wall.

9. The display system according to claim 1, wherein the display system is movably attached to a stand.

10. The display system according to claim 1, wherein the display surface and the projector are each attached to a movable mounting.

11. The display system according to claim 1, wherein the projector is fixably attached to the display surface.

12. The display system according to claim 1, wherein the display surface and the projector are movable independent of each other.

13. The display system according to claim 12, wherein the display surface is movably attached to a wall.

14. The display system according to claim 12, wherein the display surface is movably attached to a stand.

15. The display system according to claim 12, wherein the projector is movably attached to a ceiling.

16. The display system according to claim 1, wherein the projector is movably attached to a wall.

17. The display system according to claim 12, wherein the projector is movably attached to the display surface.

18. A method of adjusting the height of a display surface of a display system including a projector for projecting images on to the display surface, comprising: adjusting the display surface and the projector in a vertical direction by continuous movement.

19. The method according to claim 18, wherein the step of adjusting the display surface and the projector in a vertical direction comprises moving each a corresponding distance, such that the relationship between the projector and the display surface is unchanged.

20. The method according to claim 18, wherein said adjustment is exclusively in a vertical direction.
